(19) United States
(12) Patent Application Publication
(10) Pub. No.: US 2009/0298642 A1
(43) Pub. Date: Dec. 3, 2009

(54) ANTI ROLL BACK CONTROL SYSTEM AND METHOD FOR HYBRID VEHICLE

(75) Inventor: Kumlim Choi, Seodaemun-gu (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/477,209

(22) Filed: Jun. 3, 2009

(30) Foreign Application Priority Data
Jun. 3, 2008 (KR) 10-2008-0051956

(51) Int. Cl. B60W 10/18; B60W 20/00; G06F 19/00

(52) U.S. Cl. 477/4; 701/71

(57) ABSTRACT

An anti roll back (ARB) control system and an ARB control method are provided, which can prevent a hybrid vehicle, of which the clutch disposed between the driving wheel and the engine is open when the vehicle stops, from being unexpectedly moving downward when the vehicle is restarted on a slope.

### CROSS-REFERENCE TO RELATED APPLICATIONS

The present application is based on, and claims priority from, Korean Application Serial Number 10-2008-0051956, filed on Jun. 3, 2008, the disclosure of which is hereby incorporated by reference herein in its entirety.

### FIELD OF THE INVENTION

The present invention relates to an anti roll back (ARB) control system and method for a hybrid vehicle, which allows the vehicle to achieve stable idle stop and prevents the vehicle from being moved downward when it restarts on a steep slope.

### BACKGROUND OF THE INVENTION

In a hybrid vehicle, the clutch disposed between the engine and the driving wheel is open when the vehicle stops, including idle stop. For this reason, when the driver of the vehicle releases the brake in favor of the accelerator to restart the vehicle on a slope, power transmission to the wheels does not occur for a time period between the time when the engine is started up and the time when the clutch is engaged, causing the vehicle to be moved downward. There is thus a need for an appropriate means for solving the problem.

### SUMMARY OF THE INVENTION

In one aspect, the present invention provides an anti roll back (ARB) control system for a hybrid vehicle. The control system comprises: a hold switch that maintains, when turned on, the braking state of the vehicle even when the brake of the vehicle is released; an inclination sensor that senses the inclination of a road surface on which the vehicle stops; an ARB unit that maintains brake hydraulic pressure, until a clutch of the vehicle is engaged after the brake is released; and a control unit that receives signals from the hold switch and the inclination sensor, and controls the ARB unit according to the received signals.

In another aspect, the present invention provides a method of controlling an ARB unit of a hybrid vehicle. The ARB control method comprises: (a) determining whether the ARB unit is in OFF-state; (b) determining whether a hold switch is in ON-state if it is determined in step (a) that the ARB unit is not in OFF-state in step; (c) determining whether an ON-signal is transmitted from the accelerator position sensor if it is determined in step (b) that the hold switch is in ON-state; and (d) maintaining the ARB unit in ON-state if it is determined in step (c) that if the ON-signal is not transmitted from the accelerator position sensor.

According to the present systems and methods, the ARB unit is turned off after keeping the ARB unit for a while according to the slope angle, even if the brake is turned off. Accordingly, since barking is maintained for a while by the ARB unit even if the brake is turned off, when the vehicle driver tries to restart the vehicle on a slope way, it is possible to prevent the vehicle from being moved downward until the clutch is engaged after the engine is started, by maintaining the braking force using the ARB unit.

Further, when the ARB unit is turned on and the hold switch is also turned on while the vehicle stops, the holding function is maintained, even if the driver removes his/her foot from the brake pedal to turn off the brake, such that the vehicle is maintained in stop state by the ARB unit that continuously maintains the ON-state. Accordingly, thereafter, if the driver presses down the accelerator pedal to try to restart, the ARB unit is turned off and the vehicle can start.

In this operation, by varying the time when the ARB unit is turned off according to the degree of slope in response to a signal from the inclination sensor, it is possible to stably prevent the vehicle from being moved downward when restarting the vehicle on a slop with various degrees of the slope.

Further, when the hold switch is turned on, even if the driver removes his/her foot from the brake pedal to turn off the brake, it is possible to reduce fuel consumption and the exhaust gas due to combustion in the engine by maintaining an idle stop, when all of the other conditions for maintaining the idle stop are satisfied.

Further, according to the present invention, the braking force by the ARB unit that is maintained in ON-state, when the idle stop is released, that is, the engine is started, prevents unexpected rapid start of the vehicle, thereby helping improved safety of the vehicle.

### BRIEF DESCRIPTION OF THE DRAWINGS

For a better understanding of the nature and objects of the present invention, reference should be made to the following detailed description with the accompanying drawings, in which:

FIG. 1 is a schematic view showing an ARB control system for a hybrid vehicle according to an embodiment of the present invention; and

FIG. 2 is a flowchart illustrating an ARB control method for a hybrid vehicle according to an embodiment of the present invention.

### DETAILED DESCRIPTION OF THE PREFERRED EMBODIMENTS

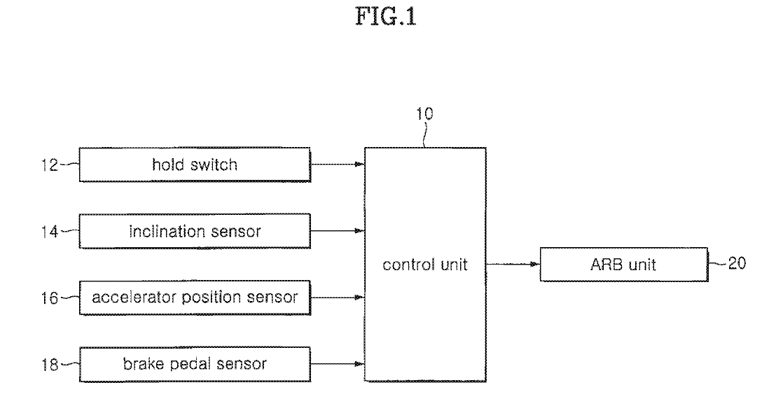

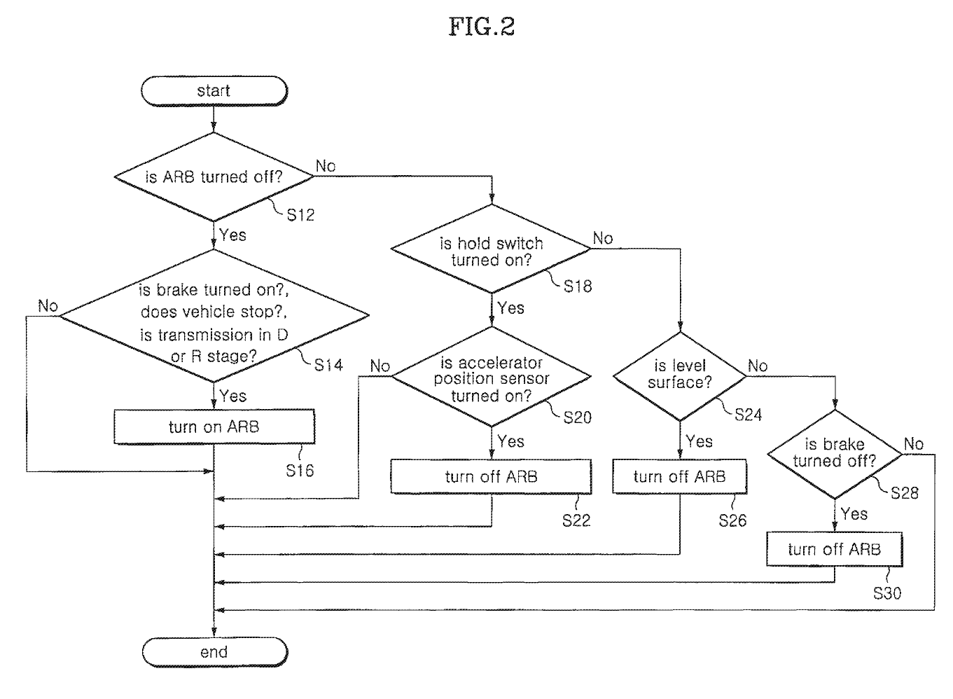

Preferred embodiments of the present invention will be described below with reference to FIGS. 1 and 2.

FIG. 1 is a schematic view showing an anti roll back control system for a hybrid vehicle according to an embodiment of the present invention.

Referring to FIG. 1, the system includes a hold switch 12, an inclination sensor 14, an ARB unit 20 and a control unit 10. The hold switch 12 may maintain braking state of the vehicle even when the brake is released. The inclination sensor 14 may sense the inclination of a road surface on which the vehicle stops. The ARB unit 20 may maintain brake hydraulic pressure until the clutch is engaged after the driver steps off the brake and starts up the engine. The control unit 10 receives signals from the hold switch 12 and the inclination sensor 14 and controls the ARB unit 20 according to the received signals.

The system may further comprise an accelerator position sensor 16 and a brake pedal sensor 18. The accelerator position sensor 16 detects the position of the accelerator and transmits the information of the position state to the control unit 10. The brake pedal position sensor 18 detects the position of the brake pedal and transmits the information of the position state to the control unit 10. The control unit 10 uses the accelerator position state and the brake pedal state to control the ARB unit 20, and uses vehicle speed and transmission signals to control the ARB unit 20.

The shape and size of the hold switch 12 are not limited to particular ones. Rather, the hold switch 12 may be designed in various ways so long as it can perform hold function properly. For instance, it may be designed so as to be operable by a driver. In this case, when the driver turns on the hold switch 12, the control unit 10 maintains the ARB unit 20 turned on such that the braking state is not released by reflecting the operational state of hold switch 12, even if the driver removes his/her foot from the brake. In this operation, the control unit 10 can instantly achieve the hold function when the vehicle is stopped or when a predetermined time has passed after the stop of the vehicle. Further, while the hold function is achieved, it is preferable to maximally maintain the idle stop function in reducing the fuel consumption and the exhaust gas of the vehicle.

Also, for instance, the hold switch 12 may be designed so as not be operable by a driver. In this case, the control unit 10 may be designed to automatically achieve the hold function when a predetermined time has passed after a vehicle stops. Alternatively, the brake pedal position sensor 18 or additional brake pedal position sensor may be used to sense when the brake pedal is more pressed down and the control unit 10 can achieve the hold function on the basis of the signal transmitted from the sensor.

The inclination sensor 14 senses the inclination of the road surface on which the vehicle stops, and transmits the inclination to the control unit 10. Subsequently, the control unit 10 prevents the vehicle from being moved downward on a slope and allows the vehicle to smoothly start on the level surface by varying the time when the ARB unit 20 is turned off according to the inclination of the road surface transmitted from the inclination sensor 14, when it should turn off the ARB unit 20.

The ARB unit 20 includes a solenoid valve therein and makes it possible to maintain brake hydraulic pressure of the wheel under the control of the control unit 10 even after the driver removes his/her foot from the brake and starts up an engine.

FIG. 2 is a flowchart illustrating an ARB control method for a hybrid vehicle according to an embodiment of the present invention.

It is determined whether the ARB unit 20 is in OFF-state (S12). If it is determined that the ARB unit 20 is in OFF-state, it is determined whether the brake is in ON-state by using a signal from the brake pedal sensor 18, whether the vehicle is stopped by using a vehicle speed signal, and whether the transmission is in D or R stage by using a transmission signal (S14). If it is determined that the brake is in ON-state, the vehicle is stopped, and the transmission is in D or R stage, the ARB unit 20 is turned on (S16).

On the other hand, if it is determined in Step S12 that the ARB unit 20 is in ON-state, it is determined whether the hold switch 12 is in ON-state (S18). If it is determined that the hold switch 12 is in ON-state, whether the accelerator position sensor 16 is in ON-state is determined (S20). If it is determined that the accelerator position sensor 16 is in ON-state, the ARB unit 20 is turned off (S22) so that the vehicle can restart. In step S22, the time when the ARB unit is turned off may vary according to the signal transmitted from the inclination sensor 14. For example, if the inclination of the road surface on which the vehicle stops is small, the ARB unit 20 is turned off according to the signal transmitted from the inclination sensor 14 after a relatively short time passes from the time of brake-off or accelerator position-on. On the other hand, if the inclination of the road surface on which the vehicle stops is large, the ARB unit 20 is turned off after a relatively long time passes.

If it is determined in Step S18 that the hold switch 12 is in OFF-state, it is determined whether the road surface on which the vehicle stops is a level surface according to the signal transmitted from the inclination sensor 14 (S24). If it is determined that the road surface on which the vehicle stops is a level surface, the ARB unit 20 is turned off (S26), in which case the vehicle can stably maintain the stop state regardless of whether the ARB unit 20 operates. On the other hand, if it is determined that the road surface on which the vehicle stops is not a level surface, it is determined whether the brake is in OFF-state (S28). If it is determined that the brake is in OFF-state, the ARB unit 20 is turned off (S30) so that the vehicle can restart. In Step S30, the time when the ARB unit is turned off may vary according to the inclination of the road surface, as described above.

What is claimed is:

1. An anti roll back (ARB) control system for a hybrid vehicle, the system comprising:
a hold switch that maintains, when turned on, the braking state of the vehicle even when the brake of the vehicle is released;
an inclination sensor that senses the inclination of a road surface on which the vehicle stops;
an ARB unit that maintains brake hydraulic pressure, until a clutch of the vehicle is engaged after the brake is released; and
a control unit that receives signals from the hold switch and the inclination sensor, and controls the ARB unit according to the received signals.

2. The system as defined in claim 1, further comprising:
an accelerator position sensor that senses an accelerator position state; and
a brake pedal sensor that senses a brake pedal state,
wherein the control unit receives signals from the accelerator position sensor and the brake pedal sensor, and controls the ARB unit according to the received signals.

3. The system as defined in claim 2, wherein if the hold switch is turned on, the accelerator position sensor is turned on, and the ARB unit is in ON-state, the control unit maintains the ARB unit in ON-state.

4. The system as defined in claim 1, wherein if the inclination of the road surface on which the vehicle stops is small, the control unit turns off the ARB unit according to the signal transmitted from the inclination sensor after a short time passes from the time of brake-off or accelerator position-on, and
if the inclination of the road surface on which the vehicle stops is large, the control unit turns off the ARB unit according to the signal transmitted from the inclination sensor after a long time passes from the time of brake-off or accelerator position-on.

5. The system as defined in claim 1, wherein the control unit receives vehicle speed and transmission signals, and controls the ARB unit according to the received signals.

6. The system as defined in claim 1, wherein the control unit controls the ARB unit so that time when the ARB unit is turned off varies according to the inclination of the road surface sensed by the inclination sensor.

7. A method of controlling an anti roll back (ARB) unit of a hybrid vehicle, the method comprising:
(a) determining whether the ARB unit is in OFF-state;
(b) determining whether a hold switch is in ON-state if it is determined in step (a) that the ARB unit is not in OFF-state in step;
(c) determining whether an ON-signal is transmitted from the accelerator position sensor if it is determined in step (b) that the hold switch is in ON-state; and
(d) maintaining the ARB unit in ON-state if it is determined in step (c) that if the ON-signal is not transmitted from the accelerator position sensor.

8. The method as defined in claim 7, further comprising:
turning off the ARB unit after a predetermined time passes, if it is determined in step (c) that the ON-signal is transmitted from the accelerator position sensor,
wherein the predetermined time varies according to the inclination of a road surface on which the vehicle stops.

9. The method as defined in claim 8, wherein if the inclination is small, the ARB unit is turned off after a short time passes from the time of brake-off or accelerator position-on, and
if the inclination is large, the ARB unit is turned off after a short long passes from the time of brake-off or accelerator position-on.

10. The method as defined in claim 7, further comprising:
determining whether a road surface on which the vehicle stops is a level surface if it is determined in step (b) that the hold switch is not in ON-state; and
turning off the ARB unit if it is determined that the road surface on which the vehicle stops is a level surface.

11. The method as defined in claim 10, further comprising:
determining whether the brake is in OFF-state if it is determined that the road surface on which the vehicle stops is not a level surface; and
turning off the ARB unit after a predetermined time passes if it is determined that the brake is in OFF-state,
wherein the predetermined time varies according to the inclination of the road surface.

12. The method as defined in claim 7, wherein further comprising:
determining whether the brake is in ON-state, whether the vehicle stops, and whether the transmission of the vehicle is in D or R stage if it is determined that the ARB unit is in OFF-state in step (a); and
turning on the ARB unit if it is determined that the brake is in the ON-state, the vehicle stops, and the transmission is in D or R stage.
